(19) United States
(12) Patent Application Publication
(10) Pub. No.: US 2006/0274530 A1
(43) Pub. Date: Dec. 7, 2006

(54) Lamp receptacle assembly for a projection apparatus

(75) Inventors: Wei-Szu Lin, Hsinchu (TW); Wan-Chang Fan, Hsinchu (TW); Jia-Bin Huang, Hsinchu (TW)

Correspondence Address: BIRCH STEWART KOLASCH & BIRCH, PO BOX 747, FALLS CHURCH, VA, 22040-0747, US

(73) Assignee: Young Optics Inc.

(21) Appl. No.: 11/444,481

(22) Filed: Jun. 1, 2006

(30) Foreign Application Priority Data
Jun. 3, 2005 (TW) 94209350

(51) Int. Cl. F21V 29/00

(52) U.S. Cl. 362/294

(57) ABSTRACT

A lamp receptacle assembly includes a receptacle body including first and second body parts having confronting peripheral edges fastened together to define a lamp chamber for receiving a lamp unit therein. The receptacle body is formed with a vent unit for ventilation of the lamp unit. At least one net unit covers the vent unit to prevent the broken pieces from scattering within the projection apparatus.

### FIELD OF THE INVENTION

The invention relates to a receptacle assembly, and more particularly to a lamp receptacle assembly for holding a lamp unit within a projection apparatus.

### BACKGROUND OF THE INVENTION

A lamp unit is provided within a projection apparatus in order to produce light rays required for projecting an image onto a distal screen for people to watch the image. The lamp unit is usually seated within a lamp receptacle in the projection apparatus.

FIG. 1 illustrates how the lamp unit 2 is seated on a conventional lamp receptacle assembly 4 in the projection apparatus. Since the conventional lamp receptacle assembly 4 has an elongated mounting plate, a majority portion of the lamp unit 2 is exposed to an exterior of the mounting plate.

The lamp unit 2 generally includes a burner for emitting light rays and a lampshade disposed behind the burner to surround the burner therearound. In case of an outbreak of the burner and the lampshade, the broken tiny pieces may scatter over the entire area within the projection apparatus, thereby inconveniencing the assembler or user to clean the broken pieces. The broken pieces may injure the assembler or the user during the cleaning process.

Moreover, in case of replacing the lamp unit 2 with new ones due to burnout or damage, the hands of the assembler or user may be injured due to the intensive heat generated by the lamp unit 2 during operation of the projection apparatus.

### SUMMARY OF THE INVENTION

It is the object of the present invention to provide a lamp receptacle assembly for use in a projection apparatus. The lamp receptacle assembly includes components, which is adapted to prevent the broken pieces from scattering within the projection apparatus.

It is an another object of the present invention to provide a lamp receptacle seat assembly having components that permit ventilation of the lamp unit so as to lower the ambient temperature within the projection apparatus.

In one aspect of the present invention, a lamp receptacle assembly is provided for holding a lamp unit within a projection apparatus, the lamp receptacle assembly including a receptacle body enclosing the lamp unit and formed with a vent unit for ventilation of the lamp unit. The lamp receptacle assembly further includes at least one net unit for covering the vent unit in the receptacle body.

In a second aspect of the present invention, a lamp receptacle assembly having a receptacle body is provided. The receptacle body includes first and second body parts having confronting peripheral edges fastened together to define a lamp chamber for receiving a lamp unit therein. The receptacle body is formed with a vent unit for ventilation of the lamp unit.

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a rear perspective view illustrating how a lamp unit is mounted on a conventional lamp receptacle assembly;

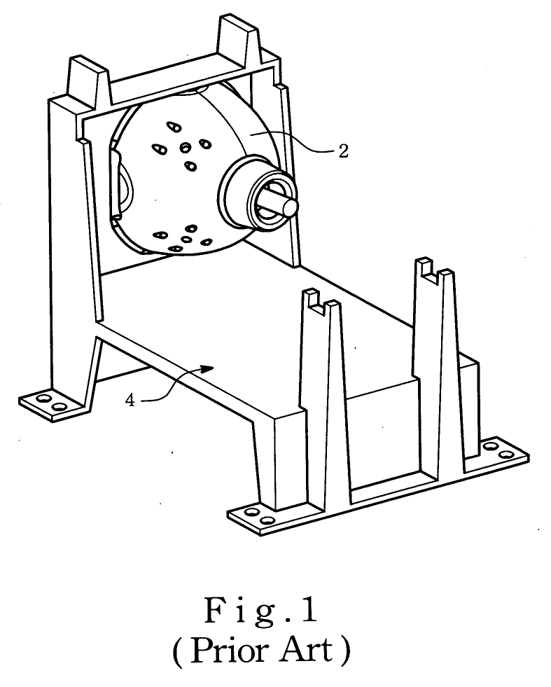

FIG. 2 is a perspective view of a lamp receptacle assembly of the present invention for holding a lamp unit within a projection apparatus; and

FIG. 3 is a perspective and exploded view of the lamp receptacle assembly of the present invention.

### DETAILED DESCRIPTIONS OF THE PREFERRED EMBODIMENT

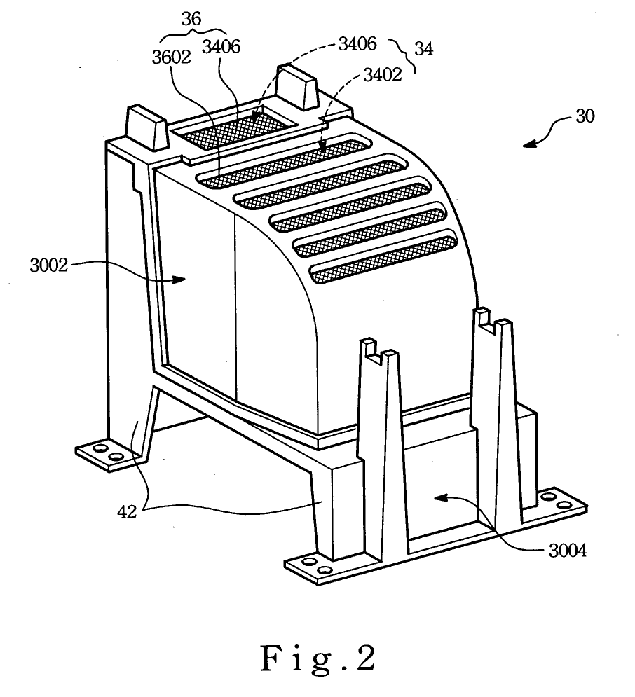

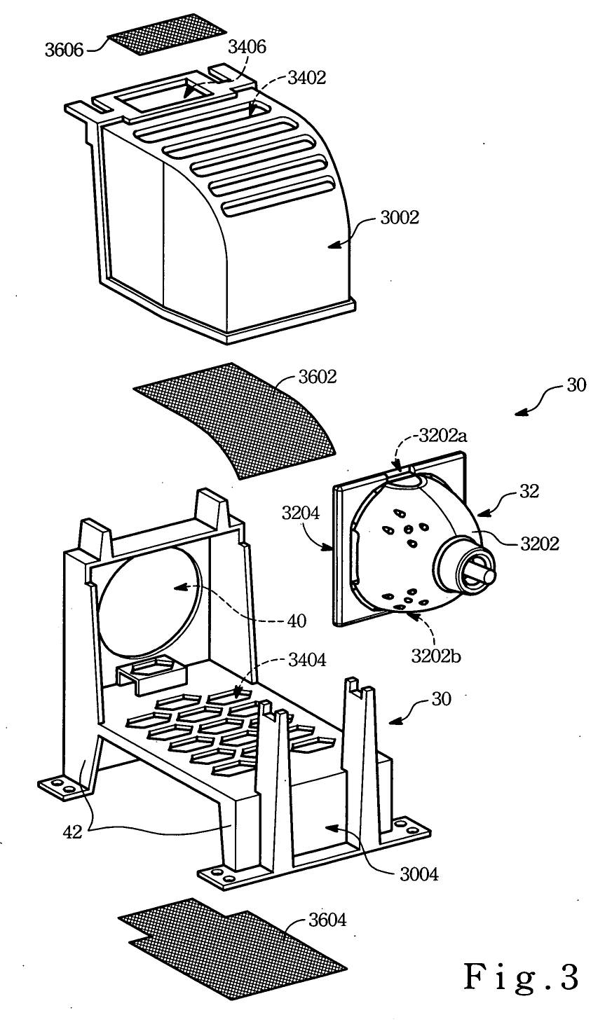

FIGS. 2 and 3 respectively show perspective and exploded views of the lamp receptacle assembly 30 of the present invention for holding a lamp unit 32 within a projection apparatus.

The lamp receptacle assembly 30 includes a receptacle body that encloses the lamp unit 32 therein and that is formed with a vent unit 34 for ventilation of the lamp unit 32. The lamp receptacle assembly 30 further includes at least one net unit 36 for covering the vent unit 34 in the receptacle body. The net unit 36 includes at least one protective net having a plurality of parallel-netted strings. Two adjacent strings of the protective net are spaced from each other at a distance ranging from 0.35 mm to 0.05 mm.

Preferably, the receptacle body includes first and second body parts 3002, 3004 having confronting peripheral edges fastened or sealed together to define a lamp chamber of the receptacle body for receiving the lamp unit 32 therein. Under this condition, no broken pieces are thrown out to an exterior of the lamp chamber in case there is an outbreak of the lamp unit 32 within the lamp chamber.

The lamp unit 32 generally includes a burner, a lampshade 3202 disposed behind to surround the burner, and a glass plate 3204 that is disposed in front of the lampshade 3202 and that cooperates with the lampshade 3202 to define an air inlet 3202a at an upper end and an air outlet 3202b at a lower end thereof.

The first body part 3002 has an upper wall formed with a first vent 3402 for guiding air into the lamp chamber. The net unit 36 includes a first protective net 3602 for covering the first vent 3402 in the first body part 3002.

The second body part 3004 has a lower wall formed with a second vent 3404 for releasing air from an interior of the lamp chamber to an exterior of the lamp chamber. The net unit 36 further includes a second protective net 3604 for covering the second vent 3404 in the second body part 3004. In this embodiment, the second body part 3004 is disposed below the lamp unit 32 in order to support the lamp unit 32 thereabove. The first body part 3002 is disposed above the second body part 3004 in such a manner to cover the lamp unit 32 from above.

The upper wall of the first body part 3002 is further formed with a third vent 3406 adjacent to the air inlet 3202a of the lamp unit 32. The net unit 36 further includes a third protective net 3606 for covering the third vent 3406 in the first body part 3002. In this embodiment, the first, second and third vents 3402, 3404, 3406 cooperatively define the vent unit 34 while the first, second and third protective nets 3602, 3604, 3606 cooperatively define the net unit 36.

Referring to FIG. 3, the receptacle body further includes a front wall that is disposed frontwardly of the lamp unit 32 and that is formed with a front opening 40 to permit extension of the light rays emitted from the burner. The glass plate 3204 is mounted on the front wall of the receptacle body so as to cover the front opening 40.

Note that the net unit 36 is preferably heat-sealed to the receptacle body for covering the vent unit 34. Alternately, a plurality of fastener screws extends through the net unit 36 for fastening the net unit 36 to the receptacle body around the vent unit 34. Since no clearance is existed between the net unit 36 and the periphery defining the vent unit 34, no broken pieces are thrown out to the exterior of the lamp chamber in case there is an outbreak of the lamp unit 32 within the receptacle body. Heat-sealing of the net unit 36 on the receptacle body in order to cover the vent unit 34 is easy to conduct and costs lesser in turn of expense when compared to using the fastener screws.

As a matter of fact, provision of the net unit 36 on the receptacle body is usually done within the inner surface so that the rough or sharp edges of the net unit 36 will be concealed within the receptacle body. Under this arrangement, the assembler or user will not be injured by the rough edges of the net unit 36. In this embodiment, the first protective net 3602 is mounted on the inner surface of the first body part 3402.

However, the second protective net 3604 is mounted on the outer surface of the second body part 3004 in order to facilitate mounting purposes and so as to cover the second vent 3404. Since the second body part 3004 has two seating portions 42 for fixing on the inner surface of the projection apparatus and obstructing the second protective net 3604, the assembler or user will not be injured by the rough edges of the second protective net 3604.

Moreover, the third vent 3406 has a relatively small dimension and it is relatively difficult to mount the third protective net 3606 on the inner surface of the first body part 3002. Since the possibility of injuring the assembler or user by the third protective net 3606 is relatively small, the latter is mounted on the outer surface of the first body part 3002 for covering the third vent 3406.

To summarize the above paragraphs, it is observable that since the confronting peripheral edges of the first and second body parts 3002, 3004 are fastened together to form the lamp chamber so as to confine the lamp unit therein, assembler or user is protected from burned by the heated lamp. The presence of the net unit 36 on the receptacle body for covering the vent unit 34 of the receptacle body eliminates the risk of injuring the assembler or user by the broken pieces. In addition, employment of the net unit does not hinder the heat-dissipating ability of the projection apparatus. The condition of the lamp unit 32 is observable from the exterior of the receptacle body via the net unit 36.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A lamp receptacle assembly for holding a lamp unit within a projection apparatus, the lamp receptacle assembly including a receptacle body enclosing the lamp unit and formed with a vent unit for ventilation of the lamp unit, the lamp receptacle assembly further comprising:
at least one net unit for covering the vent unit in the receptacle body.

2. The lamp receptacle assembly according to claim 1, wherein the receptacle body includes first and second body parts having confronting peripheral edges fastened together to define a lamp chamber of the receptacle body for receiving the lamp unit therein.

3. The lamp receptacle assembly according to claim 2, wherein the first body part has an upper wall formed with a first vent for guiding air into the lamp chamber and said net unit comprises a first protective net for covering the first vent in the first body part.

4. The lamp receptacle assembly according to claim 3, wherein the second body part has a lower wall formed with a second vent for releasing air from an interior of the lamp chamber to an exterior of the lamp chamber and said net unit further comprises a second protective net for covering the second vent in the second body part.

5. The lamp receptacle assembly according to claim 4, wherein the lamp unit includes a burner, a lampshade disposed behind to surround the burner and a glass plate that is disposed in front of the lampshade and that cooperates with the lampshade to define an air inlet and an air outlet, said upper wall of said first body part further being formed with a third vent adjacent to the air inlet, said net unit further including a third protective net for covering the third vent in the first body part.

6. The lamp receptacle assembly according to claim 5, wherein the receptacle body further comprises a front wall that is disposed frontwardly of the lamp unit and that is formed with a front opening to permit extension of the light rays emitted from the burner and the glass plate is mounted on the front wall so as to cover the front opening.

7. The lamp receptacle assembly according to claim 2, wherein the second body part is disposed below the lamp unit in order to support the lamp unit thereabove and the first body part is disposed above the second body part in such a manner to cover the lamp unit from above.

8. The lamp receptacle assembly according to claim 1, wherein said net unit comprises at least one protective net having a plurality of parallel netted strings and an adjacent pair of said netted strings are spaced from each other at a distance ranging from 0.35 mm to 0.05 mm.

9. The lamp receptacle assembly according to claim 1, wherein said net unit is heat-sealed to the receptacle body for covering the vent unit.

10. The lamp receptacle assembly according to claim 1, further comprising a plurality of fastener screws extending through said net unit for fastening the net unit to the receptacle body around the vent unit.

11. A lamp receptacle assembly comprising:
a receptacle body including first and second body parts having confronting peripheral edges fastened together to define a lamp chamber for receiving a lamp unit therein, said receptacle body being formed with a vent unit for ventilation of said lamp unit.

12. The lamp receptacle assembly according to claim 11, wherein said second body part is disposed below said lamp unit in order to support said lamp unit thereabove, said first body part being disposed above said second body part in such a manner to cover said lamp unit from above.

13. The lamp receptacle assembly according to claim -11, further comprising at least one net unit for covering said vent unit in said receptacle body.

14. The lamp receptacle assembly according to claim 13, wherein said net unit includes at least one protective net having a plurality of parallel netted strings and an adjacent pair of said netted strings are spaced from each other at a distance ranging from 0.35 mm to 0.05 mm.

15. The lamp receptacle assembly according to claim 13, wherein said net unit is heat-sealed to the receptacle body for covering the vent unit.

16. The lamp receptacle assembly according to claim 13, further comprising a plurality of fastener screws extending through said net unit for fastening said net unit to said receptacle body around said vent unit.

17. The lamp receptacle assembly according to claim 13, wherein said lamp unit comprises a burner, a lampshade disposed behind to surround said burner, and a glass plate disposed in front of said lampshade.

18. The lamp receptacle assembly according to claim 17, wherein said receptacle body further comprises a front wall that is disposed frontwardly of said lamp unit and that is formed with a front opening to permit extension of light rays emitted from said burner and said glass plate is mounted on the front wall so as to cover said front opening.
